(19) United States
(12) Patent Application Publication
(10) Pub. No.: US 2025/0310989 A1
(43) Pub. Date: Oct. 2, 2025

(54) FREQUENCY RESOURCE SHARING BETWEEN ACCESS POINTS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/006,939

(22) Filed: Dec. 31, 2024

Related U.S. Application Data
(60) Provisional application No. 63/570,501, filed on Mar. 27, 2024.
(60) Provisional application No. 63/665,835, filed on Jun. 28, 2024.
(60) Provisional application No. 63/716,526, filed on Nov. 5, 2024.

(51) Int. Cl. H04W 74/04; H04L 1/1607; H04W 28/02

(52) U.S. Cl. CPC H04W 74/04; H04L 1/1635; H04W 28/0278

(57) ABSTRACT

Methods and apparatus for coordinated time domain multiple access (C-TDMA) sharing of a wireless frequency resource by a first access point (AP) of a device. In a method, the first AP obtains a Transmit Opportunity (TXOP) for the frequency resource and transmits a Buffer Status Report Poll (BSRP) trigger frame addressed to at least a second AP. In this example, the BSRP trigger frame includes control information indicating a time allocation of the TXOP available for use by the second AP. In response to the BSRP trigger frame, the first AP receives a response frame (e.g., a QoS Null frame) including resource request information of the second AP with respect to the time allocation of the TXOP. The control information may include one or more of a duration of the time allocation, a reference bandwidth, or a start time of the time allocation.

### CROSS REFERENCE TO RELATED APPLICATIONS

The present U.S. Utility Patent Application claims priority pursuant to 35 U.S.C. § 119(c) to U.S. Provisional Application No. 63/570,501, entitled “RESOURCE REQUEST AMONG APS”, filed Mar. 27, 2024, U.S. Provisional Application No. 63/665,835, entitled “C-TDMA RESOURCE REQUEST AND AP′S TB PPDU TRANSMISSION”, filed Jun. 28, 2024, and U.S. Provisional Application No. 63/716,526, entitled “C-TDMA”, filed Nov. 5, 2024, the contents of each of which is hereby incorporated herein by reference in its entirety and made part of the present U.S. Utility Patent Application for all purposes.

### BACKGROUND

### Technical Field

This disclosure relates generally to wireless communications, and more specifically to sharing of a frequency resource between wireless access points.

### Description Of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

In such WLANs, an AP transmits data within a transmit opportunity (TXOP) after it has gained contention for a wireless medium. In general, a TXOP is a designated time duration for which the AP can transmit frames without contention, essentially giving it exclusive access to the wireless medium (or channel) for a set duration without needing to compete with other devices in a BSS. For example, an AP can transmit multiple frames during an TXOP without interruption, thereby allowing the AP to support Quality of Service (QOS) for delay sensitive applications such as voice or video. The 802.11be amendment to the 802.11 standard defines protocols that allow an AP to share a service period of the TXOP with client stations for uplink communications with the AP and peer-to-peer (P2P) non-trigger based frame exchanges. This amendment further defines an optional Triggered TXOP sharing (TXS) procedure that allows an AP to allocate a portion of an obtained TXOP to one associated non-AP.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2 illustrates an example of wireless local area network (WLAN) including a sharing access point and a shared access point in accordance with embodiments of the present disclosure;

FIG. 3 depicts an example of time allocations of a TXOP shared by an access point with other access points in accordance an embodiment of the present disclosure;

FIG. 4 depicts a timing diagram of communications to support C-TDMA operations between access points in accordance with embodiments of the present disclosure;

FIG. 5 depicts an example of a User Info field format of a BRSP trigger frame in accordance with embodiments of the present disclosure;

FIG. 6 illustrates an example of a QoS Null frame including resource request information in accordance with embodiments of the present disclosure;

FIG. 7 illustrates an example of a Multi-STA BlockAck frame including resource request information in accordance with embodiments of the present disclosure;

FIG. 8 illustrates a frame exchange sequence between a first AP MLD and a second AP MLD to negotiate a C-TDMA resource sharing agreement in accordance with an embodiment of the present disclosure;

FIG. 9 is a flow chart illustrating an example process for C-TDMA sharing of a frequency resource in accordance with an embodiment of the present disclosure; and

FIG. 10 illustrates an example of an access point according to an embodiment of the present disclosure.

### DETAILED DESCRIPTION

At present, multi-AP coordination techniques are under discussion within the IEEE. Although coordination techniques have been identified as key features for the amendment (802.11bn) to the 802.11 standard, no consensus has been reached yet on the format of the frames needed to exchange information among the APs and the rules governing, for example, coordination of multiple APs sharing a TXOP. One technique under consideration is generally referred to as Coordinated Time Division Multiple Access (C-TDMA).

C-TDMA allows a group of access points (APs) to share, in time, a single transmission opportunity (TXOP) within a given bandwidth. In this system, a sharing AP secures a TXOP and can share it with one or more coordinated APs. The APs take turns communicating during different portions of the TXOP (e.g., based on a schedule provided by the sharing AP through a schedule announcement frame or through other means). As used herein a “sharing AP” refers an AP which obtains a TXOP and initiates or participates in a C-TDMA process, and a “shared AP” refers to an AP that initiates or participates in a C-TDMA process to obtain a shared portion or time allocation of a TXOP obtained by another AP within its range. Any AP that obtains a TXOP can become a sharing AP.

The various implementations described in the following description relate generally to new or updated frame formats and methodologies for supporting and controlling a C-TDMA process. More particularly, innovative frame formats used for polling or triggering C-TDMA communications and the associated response frame formats are described to support C-TDMA features associated with the IEEE 802.11bn amendment (also referred to as Ultra High Reliability or “UHR” or “Wi-Fi 8”), and future generations, of the IEEE 802.11 standard. In further aspects, C-TDMA resource sharing agreement negotiations are described.

As used herein, the term “non-legacy” may refer to physical layer protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, the frame formats described herein may be configurable to support multiple versions of the IEEE 802.11 standard.

Particular implementations of the subject matter described in the present disclosure can be implemented to realize one or more of the following potential advantages. By enabling multi-station operations for C-TDMA, the described frame formats and methods support gains in overall network throughput (particularly in high-density environments) that will be achievable in accordance with the IEEE 802.11bn amendment of the IEEE 802.11 standard, improvements to the management of time-sensitive traffic (e.g., traffic with bounded low latency), mitigation of potential interference levels, and improvements in the efficiency of available wireless spectrum both in time and frequency.

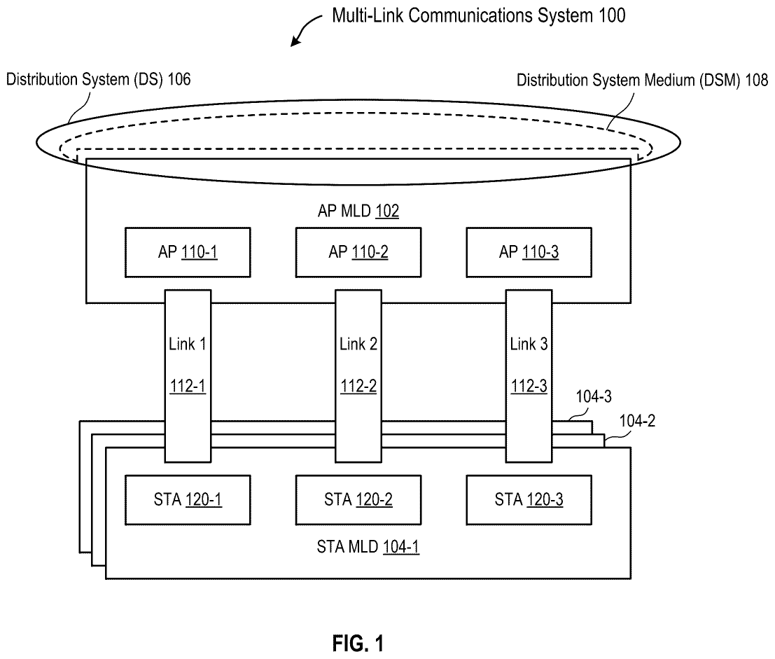

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices, which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device. In some embodiments, a common part of the AP MLD 102 implements upper layer Media Access Control (MAC) functionalities (e.g., association establishment, reordering of frames, etc.) and a link specific part of the AP MLD 102, i.e., the APs 110-1, 110-2, and 110-3, implement lower layer MAC functionalities (e.g., backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in different frequency bands. For example, at least one of the APs 110-1, 110-2, or 110-3 of the AP MLD 104 operates in an Extremely High Frequency (EHF) band or the “millimeter wave (mmWave)” frequency band. In some embodiments, a mm Wave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 5 GHz band (e.g., with a 160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop personal computer (PC), a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in a different frequency band. For example, at least one of the STAs 120-1, 120-2, or 120-3 of the STA MLD 104-1 operates in the mm Wave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 5 GHz band (e.g., with a 160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHz, 45 GHz and/or 60 GHz links.

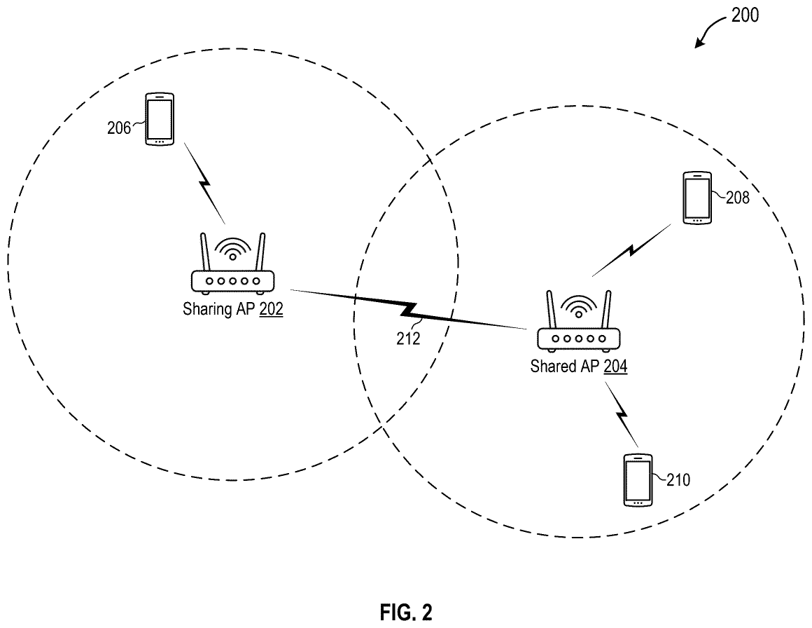

FIG. 2 illustrates an example of wireless local area network (WLAN) 200 including a sharing access point (AP) 202 and a shared AP 204 in accordance with embodiments of the present disclosure. In the illustrated example, a client STA 206 is associated with the sharing AP 202 in a first BSS and client STAs 208 and 210 are associated with the shared AP 204 in a second BSS. One or more of sharing AP 202 and shared AP 204 may be an example of the AP affiliated with an AP MLD 102 of FIG. 1 and one or more of STAs 206, 208 and 210 may be an example of the STA affiliated with a STA MLD 104 of FIG. 1.

In the illustrated example, the sharing AP 202 and the shared AP 204 have varying and overlapping coverage areas (e.g., in a high-density deployment setting) and may communicate directly via a direct wireless link 212. The sharing AP 202 and the shared AP 204 may operate on overlapping but distinct frequencies and bandwidths. In an example, the sharing AP 202 may obtain or secure a TXOP for an operating bandwidth comprising one or more channels, and the shared AP 204 may utilize one or more of the same channels, but may also operate on further channels that do not overlap with the sharing AP's channels.

In an example of C-TDMA coordinated communications, the sharing AP 202 may obtain a TXOP for a frequency resource (or wireless medium) that is also utilized by shared AP 204, and determine (e.g., via a C-TDMA resource sharing agreement negotiation) to share a time allocation of TXOP with the shared AP 204. In various examples, a shared AP may request a frequency resource from a sharing AP in either a solicited mode (e.g., in response to a polling frame from the sharing AP) or an unsolicited mode. In an example of a solicited mode, a shared AP requests a frequency resource from a sharing AP after receiving a soliciting frame (e.g., a BSRP trigger frame or other control frame). The solicited frame may be carried, for example, in a PPDU other than a TB PPDU (e.g., a UHR non-TB PPDU). In an example, the solicited frame is a QoS Null frame with a newly defined HE control field (which may also be referred to as an HE variant HT control field). In this example, the QoS Null frame does not solicit an acknowledgement (Ack) from the sharing AP. In other examples, the solicited frame is an updated Multi-STA BlockAck frame or newly defined Public Action frame (no Ack) with a newly defined HE control field.

In an example of an unsolicited mode, the shared AP transmits a QoS Null frame with a newly defined HE control field to the sharing AP to solicit an Ack from the sharing AP. In another example of an unsolicited mode, the shared AP transmits a newly defined Public Action frame (typically used for Inter-BSS and AP to unassociated-STA communications), having no frame body and a newly defined HE control field, to the sharing AP to solicit an Ack.

In another example, a TXOP sharing announcement and resource request are exchanged by the sharing AP and shared AP at the beginning of the TXOP. In this example, the sharing AP announces the time when the shared AP is scheduled through a trigger frame variant (e.g., an updated BSRP trigger frame or an updated MU-RTS TXS trigger frame). The trigger frame variant may further announce the guaranteed medium time that can be allocated to the shared AP. In a response frame, the shared AP can request more or less medium time than the guaranteed medium time announced by the sharing AP. In this example, the sharing AP may not be able to allocate medium time that is greater than the guaranteed medium time. Use of an updated MU-RTS TXS trigger frame may have the downside that an STA associated with the shared AP may reserve its NAV for all or part of the shared TXOP (referred to in the alternative as medium time).

In a further example, a shared AP may periodically send an unsolicited resource request. In this example, a periodic resource request may be carried in a newly defined Public Action frame (e.g., a management frame or a robust management frame) that includes control information such as an available time allocation of the TXOP, a reference bandwidth (BW), and the start time of the time allocation of the TXOP. In any of the foregoing examples, the shared AP 204 may transmit and receive data communications with STA 208 and STA 210 after receiving a time allocation of a TXOP of the sharing AP 202.

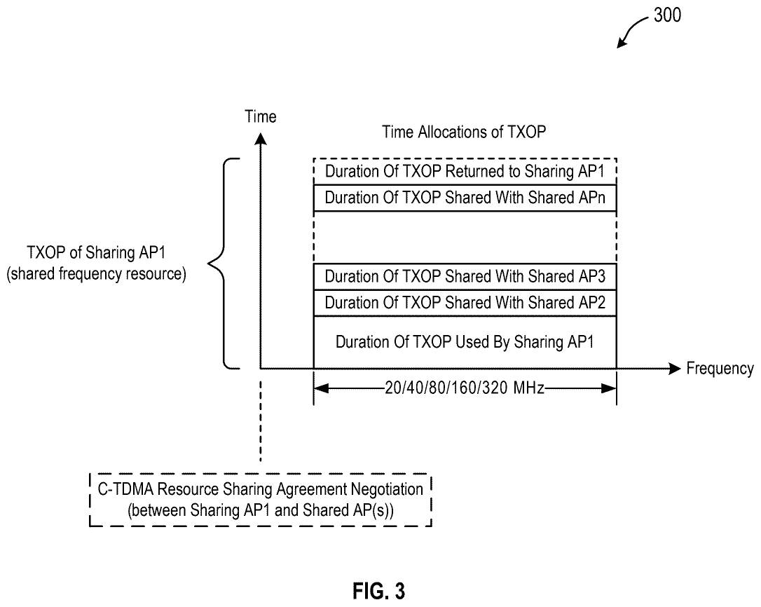

FIG. 3 depicts an example of time allocations of a TXOP shared by an access point with other access points in accordance an embodiment of the present disclosure. In the illustrated example, a sharing AP1 obtains a TXOP and allocates (e.g., shares, grants or assigns) one or more portions of the TXOP (“time allocations”) with one or more coordinated APs (“shared APs”). The sharing AP1 may obtain the TXOP using, for example, CSMA/CA and enhanced distributed channel access (EDCA) techniques. In an example, a bandwidth of the TXOP 20 MHz, 40 MHz, 80 MHz, 160 MHz, 320 MHz (or more). The bandwidth may include, for example, a primary 20 MHz channel and one or more secondary channels (e.g., 20 MHz, 40 MHz, 80 MHz, or 160 MHz channels).

In the illustrated example of FIG. 3, the sharing AP1 utilizes a first duration of the TXOP, allocates a second duration of the TXOP to shared AP2, allocates a third duration of the TXOP to shared AP3, etc. In an example, the sharing AP1 may reserve additional durations of the TXOP for its own use. In another example, if a shared AP does not need or use any of the duration of a time allocation of the TXOP that it has granted, the shared AP may return the remaining portion of the time allocation to the sharing AP1 for its use or re-allocation. In another example, the time allocations of the TXOP shared with a plurality of shared APs may or may not be equal. In a further example, the time allocations need not be contiguous in time.

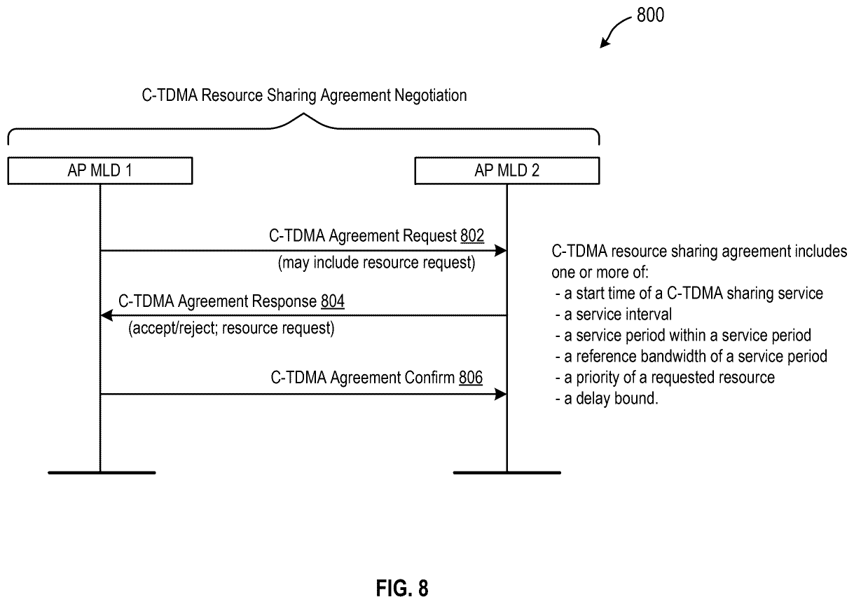

In an example, the sharing AP1 may grant the time allocation(s) of a TXOP to one or more shared APs following a C-TDMA resource sharing agreement negotiation that includes a (C-TDMA) frame exchange sequence with the shared APs and, in some instances, other APs within communication range of the sharing AP. An example of a C-TDMA resource sharing agreement negotiation is described more fully below with reference to FIG. 8.

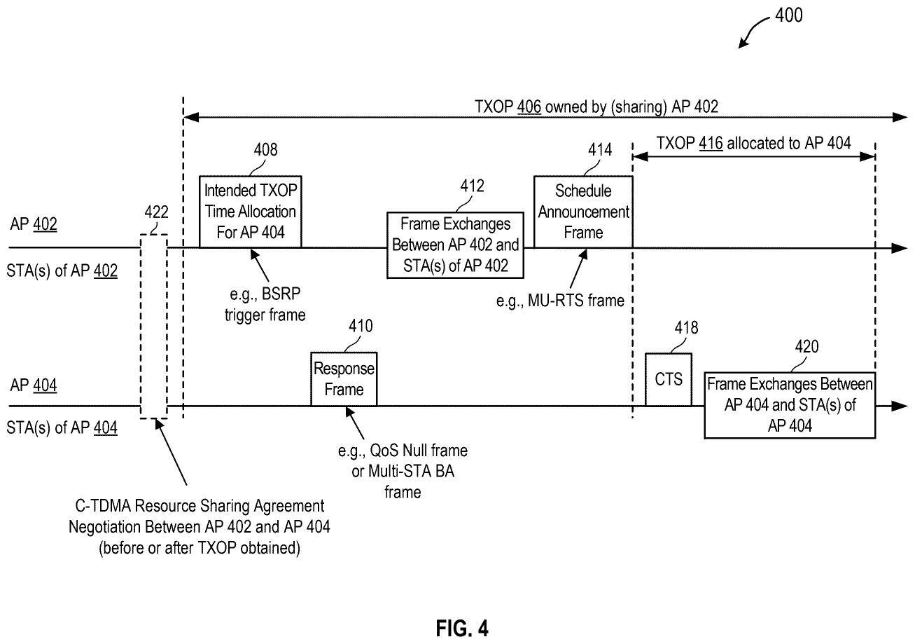

FIG. 4 depicts a timing diagram 400 of communications to support C-TDMA operations between access points in accordance with embodiments of the present disclosure. In the illustrated example, a sharing AP 402 obtains a TXOP 406 and allocates a portion (TXOP 416) of the TXOP 406 to shared AP 404. In this example, the TXOP 406 may be preceded by a C-TDMA resource sharing agreement negotiation 422 between the sharing AP 402 and the shared AP 404, an example of which is described below with reference to FIG. 8. In an example, the C-TDMA resource sharing agreement negotiation 422 occurs before the sharing AP 402 obtains the TXOP 406. In another example, the C-TDMA resource sharing agreement negotiation 422 occurs after the sharing AP 402 obtains the TXOP 406.

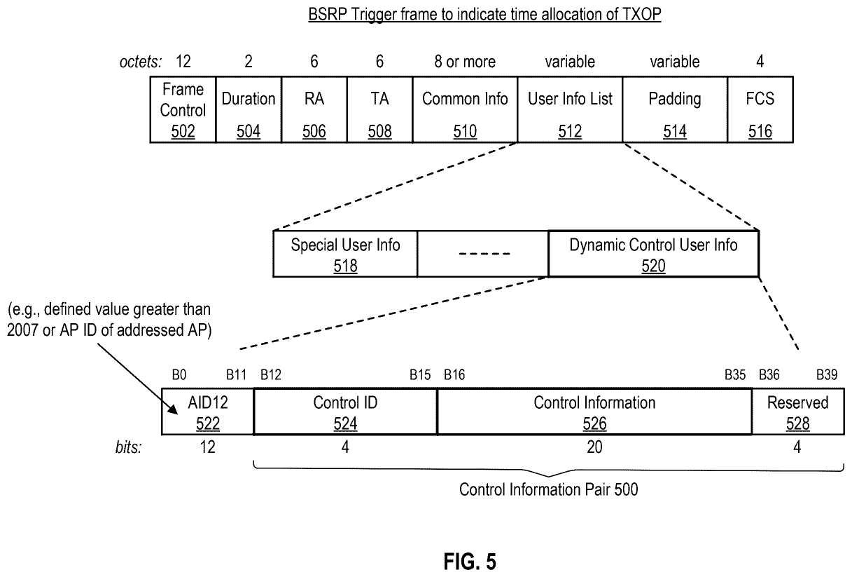

In the illustrated example, after the sharing AP 402 obtains the TXOP 406, the sharing AP 402 transmits (at 408) a frame (e.g., a polling frame) addressed to the shared AP 404 including control information indicating an advised time allocation and other information (e.g., advised TID where the shared AP 404 needs to exchange the frames of the advised TID with its associated STAs) of the TXOP 406 available for use by the shared AP 404. In an example, the frame is a BSRP trigger frame, an example of which is described in conjunction with FIGS. 5. In this example, the BRSP trigger frame may function as an initial control frame (ICF) to indicate an intended media time/time allocation and advised TID of a TXOP 406 (e.g., TXOP 416) for use by the shared AP 404, and to solicit a response (e.g., acceptance or rejection) from the shared AP 404. The control information included in the BSRP trigger frame may include an available time allocation of the TXOP 406, a reference bandwidth (BW), and/or the start time of the time allocation of the TXOP 406. In some embodiments, the reference BW is implicitly indicated by the BW of the (non-HT duplicate) PPDU carrying the ICF. In a further example, the BSRP trigger is transmitted in accordance with a C-TDMA resource sharing agreement between the sharing AP 402 and the shared AP 404.

In response to the (polling) frame from the sharing AP 402, the shared AP 404 transmits (at 410) a response frame (e.g., a Multi-STA BA frame) addressed to the sharing AP 402, the response frame including resource request information of the shared AP 404 with respect to the time allocation and other information. In an example, the resource request information includes a requested medium time, reference bandwidth information, a TID value, and/or packet queuing time information of the second AP with respect to the available time allocation of the TXOP 406. In this example, the referenced BW may be implicitly indicated by the BW of the PPDU carrying the soliciting frame. In a further example, a special value in the resource request information (e.g., a value of 0 for the requested medium time) contains an explicit indication of the rejection of the time allocation of the TXOP 406 to the shared AP 404. In this example, values of resource request information other than the special value (e.g., the value 0) of the requested medium time, indicate the acceptance of the time allocation of the TXOP 406 to the shared AP 404. After receiving a response frame to confirm the TXOP time allocation, the sharing AP 402 (at 412) may utilize a portion of the TXOP 406 to conduct frame exchanges with its associated client STA(s).

Otherwise, the sharing AP 402 announces the allocated TXOP time to the shared AP 404 by transmitting a schedule announcement frame (at 414), such as a MU-RTS frame. The schedule announcement frame may contain information such as a duration of a TXOP 416 allocation for use by the shared AP 404, where the duration starts right after the PPDU carrying the MU-RTS frame. The sharing AP 402 may determine this information, for example, based on the requested medium time of shared AP 404 and the priority (TID) of the traffic, and the available TXOP time of the sharing AP's TXOP remaining time. The schedule announcement frame is used to assist the shared AP 404 in organizing its communications with its associated client STAs for the upcoming TXOP 416. After receiving the schedule announcement frame, the shared AP 404 responds with, e.g., a CTS frame 418. The shared AP 404 may then perform (at 420) frame exchanges with its associated client STA(s).

Various options are described below in conjunction with FIGS. 5-7 for updated frame formats for C-TDMA frame exchanges between a sharing AP and one or more sharing APs. In an example, a frame exchange sequence includes an initial control frame (alternatively referred to herein as a polling frame) carrying control information indicating a time allocation of the TXOP of a sharing AP available for use by shared AP and an initial response frame (alternatively referred to as a response frame) including an indication of whether the time allocation is accepted and, if so, resource request information of the shared AP with respect to the time allocation of the TXOP. In a first option, the polling frame is an updated BSRP trigger frame and the response frame is an updated QoS Null frame. In a second option, the polling frame is an updated BSRP trigger frame and the response frame is an updated Multi-Sta BlockAck frame. In a third option, the polling frame is an updated BSRP trigger frame and the response frame is either an updated Multi-Sta BlockAck frame under control frame protection or a BSRP trigger frame under no control frame protection.

In an example, a polling frame may be addressed to more than one shared AP or only one shared AP. In another example, a polling frame may be addressed to a shared AP as well as one or more client STAs of the shared AP. Various other options for response frames, the contents of the control information and resource request information, frame sequence, etc. are further described below.

In one embodiment of C-TDMA, the sharing AP may solicit associated STAs and a shared AP in the same polling frame. In this scenario, when the resource units (RUs) of the shared AP and an associated STA are in the same 20 MHz channel, the BSS color field in the PHY header of the 20 MHz channel may not be decoded correctly by a third party STA/AP if the shared AP and the associated STA fill the BSS Color field of the PHY header with different values.

Various approaches may be employed to handle BSS color information in frame exchanges between a sharing AP and shared AP. In an example, a BSS color of the TB PPDU carrying the response frame (e.g., QoS Null frame or Multi-STA BlockAck frame) may be defined. In one example, since a shared AP is not associated with the sharing AP, the BSS color of a PPDU header between the two devices is set to 0. In another example, when the Trigger frame soliciting the response frame is carried in a PPDU (e.g., a TB PPDU) with a PHY header carrying the BSS color, the shared AP transmitting response frame will use the sharing AP's BSS color in the PHY header of the PPDU (e.g., TB PPDU) carrying the response frame. In a further example, the polling frame can be carried in a PPDU with a BSS color in the PHY header, where an HE, EHT, or UHR PPDU can be used. The BSS color in the PHY header of the PPDU carrying the polling frame will be used in the TB PPDU's PHY header by the shared AP and its associated STA(s). For example, the response frame can be in a UHR PPDU. In yet another example, the RU for a shared AP and the RU for STAs associated with the sharing AP are in different 20 MHz channels. In yet another example, the polling frame solicits a response frame in a non-TB PPDU (non-HT duplicate PPDU) from only a single shared AP.

With respect to a padding requirement of the shared AP, a shared AP may need additional time to prepare the response frame solicited by the sharing AP. In one option, the sharing AP can assume that the sharing AP requires a fixed value for the padding requirement (e.g., 16 us). In another option, the shared AP notifies the sharing AP of its padding require during a C-TDMA resource sharing agreement negotiation.

FIG. 5 depicts an example of a User Info field format of a BRSP trigger frame in accordance with embodiments of the present disclosure. In the illustrated example, the BRSP trigger frame functions as an initial control frame (ICF) (the polling frame) to indicate an intended media time/time allocation of a TXOP for use by a shared AP, and to solicit a response (e.g., acceptance or rejection) from the shared AP. As described more fully below, a sharing AP uses the illustrated BSRP Trigger addressed to a shared AP to provide a Control Information Pair 500 (which may be collectively referred to as “control information”) that includes an available time allocation of the TXOP, a reference bandwidth (BW), and the start time of the time allocation of the TXOP. In an alternative example, the reference BW is explicitly indicated by the BW of the PPDU carrying BSRP Trigger frame. In another example, the BSRP trigger frame functions as a schedule announcement frame at the beginning of a TXOP. In other examples, a Control Information Pair 500 can be the control information for a single shared AP or multiple shared APs.

In an example, the BSRP trigger frame is a MAC control frame included in a PPDU transmitted by an access point (e.g., AP MLD 102) to one AP or a plurality of APs/client stations, and includes a control information pair(s), resource unit allocation indications and other transmission parameters to be used for transmission of an uplink OFDMA or UL MU MIMO data unit during a transmit opportunity (TXOP). For example, the BSRP trigger frame may be included in a PPDU that conforms with the IEEE 802.11bn, 802.11be or other amendment to the IEEE 802.11 standard. In some examples, the BSRP trigger frame can be used by a sharing AP to solicit a response frame in a non-TB PPDU carrying various control information (e.g., whether to accept the shared TXOP time, and the shared time information) in a control frame.

The BSRP trigger frame of the illustrated example includes a plurality of fields, including a Frame Control field 502, a Duration field 504, a first address field (e.g., a receiver address (RA) field) 506, a second address field (e.g., a transmitter address (TA) field) 508, a Common Information (“Common Info”) field 510, a User Information (“User Info”) List field 512, a Padding field 514 having zero or more padding bits, and a frame check sequence (FCS) field 516. The number of octets of bits allocated to each field of the BSRP trigger frame, according to this example, is indicated in FIG. 5 above the corresponding field.

In an example, the frame control field 502 includes a plurality of subfields including a type subfield indicating that the frame is a control frame and a subtype subfield indicating a subtype (e.g., a value of 4 for a BSRP trigger type) of the frame. In another example, the FCS field 516 is a 32-bit field containing a 32-bit CRC value. The FCS is calculated over all the fields (i.e., “calculation fields”) of the MAC header and the frame body fields. The FCS value may be calculated and appended to a trigger frame by an AP prior to transmission. Upon receipt of the trigger frame by a client STA, the client STA can calculate an FCS value for the frame and compare it with the FCS value calculated by the AP. If the two FCS values match, it is assumed that the frame was not corrupted during transmission. If the two FCS values are different, an error is assumed and the frame is discarded. The Padding field 516 is optionally present in BRSP trigger frame. In an example, the Padding field 516, if present, is at least two octets in length and is set to all Is.

The Common Info field 510 and User Info List field 512 carry configuration information which may be used by a receiving device to configure a TB PPDU that is transmitted in response to receiving a BSRP trigger frame unless the BSRP Trigger frame solicits a non-TB PPDU. For example, the User Info List field 512 may include one or more User Information (“User Info”) fields, each of which carries per-user information defining the UL transmission parameters for a respective user to transmit a TB PPDU in its RU, while the Common Info field 510 may carry information that is common to all recipients (e.g., any users associated with the User Info fields of the User Info List field 512) of the trigger frame.

In the illustrated example, the User Info List field 512 includes a Special User Info field 518 (introduced in 802.11bc) followed by a plurality of User Info fields. The Special User Info field 518 is a User Info field that does not carry user specific information for an addressed STA but carries extended common information not provided in the Common Info field. The Special User Info field 518 is distinguished from a User Info field by a special AID12 value (2007). In an example, the Special User Info field 518 includes a PHY Version Identifier subfield value that can be set to identify a trigger frame as an EHT variant trigger frame or UHR variant trigger frame. The Special User Info field is optionally present in a BSRP trigger frame that is generated by an EHT AP. As specified in 802.11.be, all User Info fields (including the Special User Info field) in the User Info List field of a trigger frame have the same length unless the trigger frame is an MU-BAR trigger frame.

Each User Info field is associated with a respective AID value. The AID value may be a 12-bit value carried in the AID12 subfield (in bit positions B0-B11) of a User Info field. In an example, the AID value may uniquely identify a particular STA (or user) in a BSS. Each STA may be assigned a unique AID value, for example, upon associating with the BSS. In addition to an AID12 subfield, each User Info field is defined to include an RU allocation subfield, a UL FEC Coding Type subfield, a UL EHT-MCS subfield, a reserved bit, an SS Allocation subfield, a UL Target Receive Power subfield, a PS160 subfield, and a Trigger Dependent User Info field of variable length. Additional (or modified) subfields may be included in the IEEE 802.11bn amendment to accommodate new features and capabilities while maintaining backwards compatibility with earlier versions of the 802.11 standard. In an example, the User Info field that defines the TB PPDU transmission parameters of a shared AP carries an AID value allocated by the sharing AP to the shared AP. In this example, the sharing AP may allocate the AID value to the shared AP during a C-TDMA resource sharing agreement negotiation.

In this example, the User Info List field 512 of the BSRP trigger frame further includes a newly defined Dynamic Control User Info field 520 that includes control information for C-TDMA operations (e.g., to solicit a shared AP's C-TDMA operation). In the illustrated example, bit 0 through bit 11 of the Dynamic Control User Info field 520 include an AID12 subfield 522. The AID12 subfield 522 may include an AID value of a shared AP allocated by the sharing AP to indicate that the Dynamic Control User Info field 520 includes the Control Information pair 500 for the shared AP, or a newly defined value (e.g., greater than 2007) that indicates the Dynamic Control User Info field 520 carries the Control Information Pair 500 for multiple shared APs. In one example, Dynamic Control User Info field 520 immediately follows the User Info field carrying the TB PPDU transmission parameters for the shared AP.

In this example, the Control Information Pair 500 includes the Control ID subfield 524 and the Control Information subfield 526 provided in bit 12 through bit 39 of the Dynamic Control User Info field. The Control Information Pair 500 includes a Control ID subfield 524 (bit 12 through bit 15) and a Control Information subfield 526 (bit 16 through bit 39) having reserved bits 528 (bits 36 through bit 39). A specific value in the Control ID subfield 524 indicates that the Control Information includes information that solicits a responsive C-TDMA operation (e.g., a polling frame) from a shared AP. In a non-limiting example, the Control ID subfield 524 identifies a C-TDMA TXOP time sharing polling by a sharing AP that transmits the BSRP trigger frame to a shared AP that receives the BSRP trigger frame.

The Control Information subfield 526 of the illustrated example generally includes information that indicates an advised duration of an intended time allocation of a shared TXOP (referred to in the alternative as medium time), an advised start time of the intended time allocation, a TID whose frames can be exchanged during the shared time, and (optionally) a reference bandwidth of the TXOP. The duration of an intended time allocation may be indicated, for example, in units of microseconds (e.g., 16 us, 32 us, 64 us, etc.), as a number of symbols, as a time slot reference, etc. In an example, the duration of an intended time allocation information is a 10 bit value in the Control Information subfield 526, although a greater number of bits or a lesser number of bits may be used. In another example, the duration of an intended time allocation information is a 9 bit value plus a granularity bit that selects a unit of time from two defined units.

The start time for an intended time allocation may include a relative or absolute time at which the time allocation will become available to a shared AP. In an example, the start time information is indicated as a time difference between the end of the PPDU carrying the BSRP Trigger and the beginning of the intended time allocation. In another example, the start time information is indicated with reference to a timing synchronization function (TSF) timer. In another example, the start time of the intended time allocation information is a 10 bit value (although a greater number of bits or a lesser number of bits may be used) conveyed in units of 16 us or 32 us.

In a further example, a reference bandwidth for the intended time allocation is implicitly indicated by the BW of the PPDU carrying the initial control frame. If included in the Control Information subfield 526, reference bandwidth information (e.g., a 3 bit value) may include, for example, an indication of a center frequency, a specific bandwidth value, or a combination thereof.

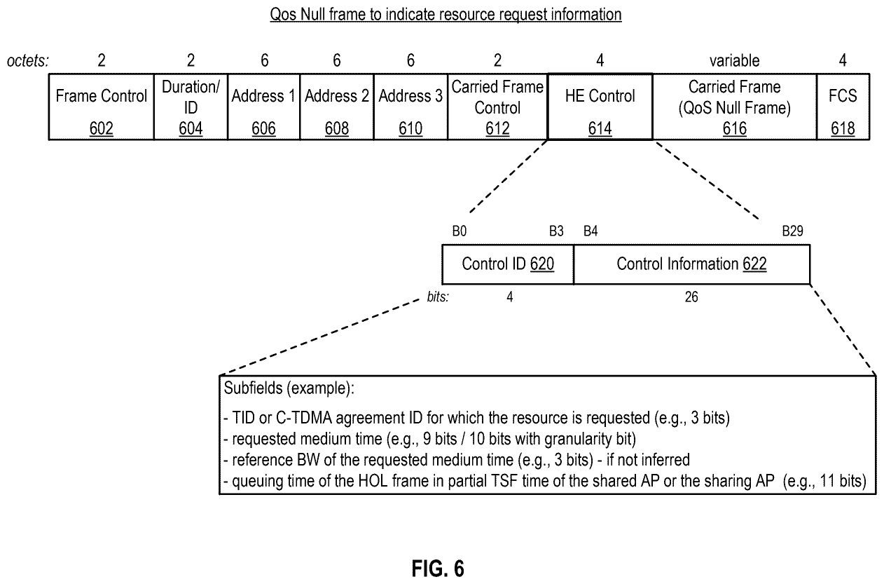

FIG. 6 illustrates an example of an updated QoS Null frame as a response frame including resource request information of a shared AP in an HE Control field 614. A QoS null frame is a Data frame type that contains no data payload but is used to signal a change in Quality of Service (QOS) parameters or power management status. A primary use of a legacy QoS null frame is to communicate to an AP that a device is entering or exiting a power-saving mode (e.g., by setting the “Power Management” bit in a frame control field).

The QOS Null frame of the illustrated example includes a plurality of fields, including a Frame Control field 602, a Duration/ID field 604, an Address 1 field 606 (e.g., a receiver address), an Address 2 field 608 (e.g., a transmitter address), an Address 3 field 610, a Carried Frame Control field 612, the High Efficiency (HE) Control field 614 (also referred to as an “HE variant HT Control field”), a Carried Frame (QOS Null Frame) field 616, and an FCS field 618. As defined by the 802.11ax amendment to the 802.11 standard, the HE Control field 614 is conventionally utilized to carry various control information, and is only present QoS Data and Management frames (e.g., when a +HTC subfield in the Frame Control field is set to 1). The HE Control field 614 of this example is redefined to include resource request information of a shared AP with respect to an intended time allocation of a TXOP (e.g., as indicated in an updated BSRP trigger frame transmitted by a sharing AP).

In the illustrated example, the HE Control field 614 includes a Control ID subfield 620 (bit 0 through bit 3) and a Control Information subfield 622 (bit 4 through bit 29). The Control ID subfield 620 may be set to a newly defined value which indicates that the HE Control field 614 includes resource request information of a shared AP.

The Control Information subfield 622 may include various resource request information depending, for example, on whether a shared AP accepts an intended time allocation of a TXOP, rejects an intended time allocation of the TXOP, or notifies a sharing AP of the shared AP's requested medium time under the reference BW in the TXOP. In the illustrated example, the Control Information subfield 622 includes: a 3 bit subfield to carry a TID or C-TDMA agreement identifier for which the resource is requested; a 9 bit subfield to carry a requested medium time value (e.g., in units of 32 us, 64 us, or 128 us) or a 10 bit subfield to carry a requested medium time value plus a defined granularity bit used to select between two different units of time; a 3 bit subfield to carry a reference bandwidth value (may be omitted if, for example, the reference bandwidth value is implicitly indicated by the bandwidth of a soliciting PPDU); and an 11 bit subfield to carry the queuing time of a head-of-line (HOL) frame in partial TSF time of the shared AP or the sharing AP, e.g., TSF[20:10]. In other examples, the length of the foregoing subfields may include a greater number of bits or a lesser number of bits.

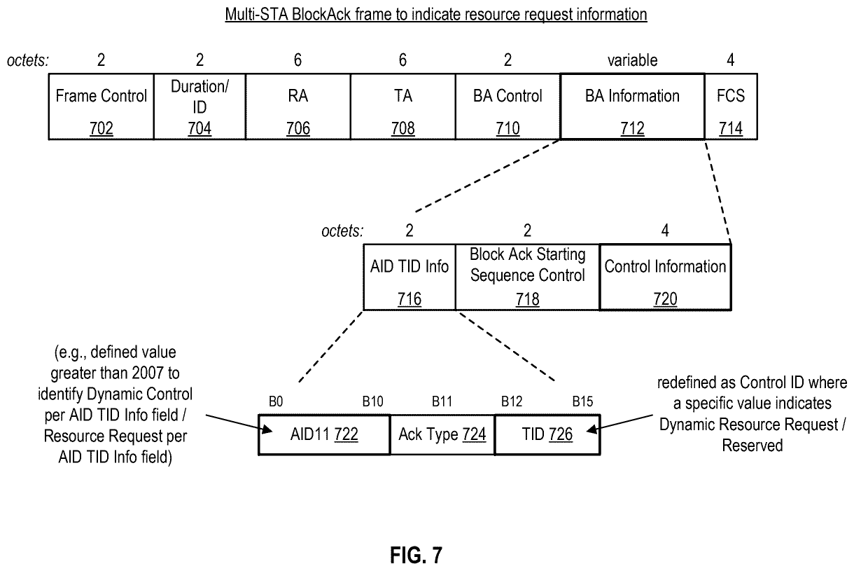

In other examples, the Control Information subfield 622 may include defined values to indicate whether or not a shared AP accepts an intended time allocation of a TXOP. In an example, the bits of the Control Information subfield 622 may be set to all 0's or all 1's to indicate that shared AP rejects a time allocation. In this example, if a value of the Control Information subfield 622 that is not all 0's or all 1's indicates that the shared AP accepts a time allocation. Continuing with this example, setting a single bit of the Control Information subfield 622 to 0 can be used to indicate that the shared AP accepts a time allocation without resource request information. Similar defined values can likewise be applied to the control information of the Multi-STA BlockAck frame described with reference to FIG. 7.

FIG. 7 illustrates an example of an updated Multi-STA BlockAck frame including resource request information of a shared AP in a BA Information field. The Multi-STA BlockAck frame of the illustrated example includes a plurality fields, including a Frame Control field 702, a Duration/ID field 704, an RA field 706, a TA field 708, a BA Control field 710, a BA Information field 712, and an FCS field 714. The BA Information field 712 of this example includes a (redefined) Per AID TID Info field 716, a Block Ack Starting Sequence Control field 718, and a Control Information field 720. In this example, a Block Ack Bitmap of field of a legacy Multi-STA BlockAck frame is redefined as the Control Information field 720. The Per AID TID Info field 716 of this example includes an AID11 subfield 722, an Ack Type subfield 724, and a Traffic Identifier (TID) subfield 726.

Referring more specifically the Per AID TID Info field 716, this field As currently defined this field includes an AID value that uniquely identifies a specific STA within a group of STAs being addressed in a multi-station aggregation scenario, and a TID value that specifies a data stream within an STA's traffic. In one embodiment, the illustrated AID11 subfield 722 (bit 0 through bit 10) is redefined to include a special value, such as a defined value greater than 2007, to identify a Dynamic Control Per AID TID Info field. In this example, the Ack Type subfield 724 (bit 11) is set to 1 and the TID subfield 726 (bit 12 through bit 15) is redefined as a Control ID subfield where a specific value indicates the resource request. In another variant of this example, 4 bits of a Starting Sequence Number subfield of the Block Ack Starting Sequence Control field 718 are repurposed as the Control ID subfield. In this example, the Fragment Number subfield of the Block Ack Starting Sequence Control field 718 has a specific value to indicate a 4-octet Control Information field.

A dynamic resource request may indicate a resource request that is different than a previously negotiated “static” resource request. A static resource request typically refers to a request for network resources that does not change dynamically based on current network conditions. Such network resources may involve fixed allocations of bandwidth or channels that are preconfigured or, in an example, negotiated during a C-TDMA resource sharing agreement negotiation such as described with reference to FIG. 8.

In a different example, the illustrated AID11 subfield 722 is redefined to include a special value, such as a defined value greater than 2007, to identify a Resource Request Per AID TID Info field. In this example, the Ack Type subfield 724 is set to 1 and the TID subfield 726 is reserved.

In the illustrated example, the Control Information field 720 can include a 4 bit subfield to carry a TID value or C-TDMA resource sharing agreement identifier associated with the requested resource. The Control Information field 720 of the illustrated example further includes a 10 bit subfield including a requested medium time (e.g., in units of 32 us, 64 us or 128 us). In another example, this subfield further includes a granularity bit to select a unit of time from two defined units. The Control Information field 720 of this example further includes a 3 bit subfield that carries a reference bandwidth for the requested medium time. In alternate embodiment, the reference bandwidth for the requested medium time can be implicitly indicated by the bandwidth of a soliciting PPDU.

Continuing with this example, the Control Information field 720 further includes a 12 bit subfield that carries a queuing time value of an HOL frame in partial TSF time of the shared AP or the sharing AP (e.g., TSF[20:10]). This value may be based on a standardized timing synchronization function (TSF) used to synchronize the timers for all stations of a basic service set. In an example, a shared AP may announce its delay bound during a C-TDMA resource sharing agreement negotiation. The lengths of the foregoing subfields of the Control Information subfield are provided by way of example, and differing implementations may have subfields including a greater number of bits or a lesser number of bits.

FIG. 8 illustrates a frame exchange sequence between a first AP MLD and a second AP MLD to negotiate a C-TDMA resource sharing agreement in accordance with an embodiment of the present disclosure. The C-TDMA resource sharing agreement can establish, for example, static time allocations for a shared TXOP (e.g., an approximate start time and duration of a TXOP allocation) in a link of the two AP MLDs. In an example, the first AP MLD, second AP MLD and/other additional AP MLDs may advertise the availability or potential availability of resources of a link prior to or during the C-TDMA resource sharing agreement negotiation for the link. In another example, a QoS Characteristic element for Stream Classification Service (SCS) or a newly defined element is utilized to carry a static resource request. In the illustrated embodiment, the C-TDMA resource sharing agreement includes the following frames: a C-TDMA agreement request 802 (which may include a resource request(s)), a C-TDMA agreement response 804, and a C-TDMA agreement confirm 806.

In an example, the C-TDMA agreement request 802 sent by AP MLD 1 to AP MLD 2 may carry a resource request for AP MLD 1 (unless the resource sharing agreement is established by another procedure, such as an SCS procedure or other resource sharing agreement negotiation). In an example, the resource request for AP MLD 1 can include one or more of: a start time of a C-TDMA sharing service being provided by AP MLD 2, a service interval (maximal service interval, minimal service interval), a service period within a service period, a reference bandwidth of the service period (or link where the sharing service is provided), a priority of a requested resource (e.g., in TID format), a delay bound, etc. If the resource request is accepted by AP MLD 2, the C-TDMA agreement response 804 sent by AP MLD 2 to AP MLD 1 may include the accepted resource request and, optionally, a resource request for AP MLD 2. If a resource request for AP MLD 2 is included and accepted by AP MLD 1, AP MLD 1 may send a C-TDMA agreement confirm 806 frame. If the resource request is rejected, the C-TDMA agreement response 804 may include an indication of the rejection and, in an example, the negotiation is concluded.

In an example wherein a resource request from AP MLD 1 is accepted by AP MLD 2, the C-TDMA agreement response 804 may include the start time of the C-TDMA sharing service being provided by AP MLD 2, the service interval (e.g., a value between the maximal service interval and minimal service interval indicated by the request from AP MLD 1), the service period within a service period (which may be updated by AP MLD 2 or, alternatively, fixed if the resource request is accepted), a reference bandwidth of a service period/link where the sharing service is provided (with no change to the resource request of AP MLD 1), a priority of a requested resource (with no change to the resource request of AP MLD 1), and a delay bound (with no change to the resource request of AP MLD 1).

In an example wherein AP MLD 2 includes a resource request in the C-TDMA agreement response 804, the resource may include the following parameters: the start time of the C-TDMA sharing service being provided by AP MLD 1, the service interval (maximal service interval, minimal service interval), the service period within a service period, the reference bandwidth of the service period (or link where the sharing service is provided), the priority of the requested resource (e.g., in TID format), the delay bound, etc. In an example, the resource allocated to AP MLD 1 by AP MLD 2 in terms of accepted medium time/reference bandwidth per second is not necessarily less than the resource request of AP MLD 2 in terms of requested medium time/reference bandwidth per second. In another example, if the service period requested by AP MLD 1 is not decreased, AP MLD 2 can have any requested service interval and requested service period.

In response to a resource request from AP MLD 2, the C-TDMA agreement confirm 806 transmitted by AP MLD I can include, for example, the start time of the C-TDMA sharing service (no change to request by AP MLD 2, the service interval (e.g., a value between the maximal service interval and minimal service interval indicated by the request from AP MLD 2), the service period within a service period (which may be updated by AP MLD 2), a reference bandwidth of a service period/link where the sharing service is provided (with no change to the resource request of AP MLD 2), a priority of a requested resource (with no change to the resource request of AP MLD 2), and a delay bound (with no change to the resource request of AP MLD 2). In an example, the resource allocated to AP MLD 1 by AP MLD 2 in terms of accepted medium time/reference bandwidth per second is not necessarily less than the resource request allocated to AP MLD1 by AP MLD 2 in terms of requested medium time/reference bandwidth per second.

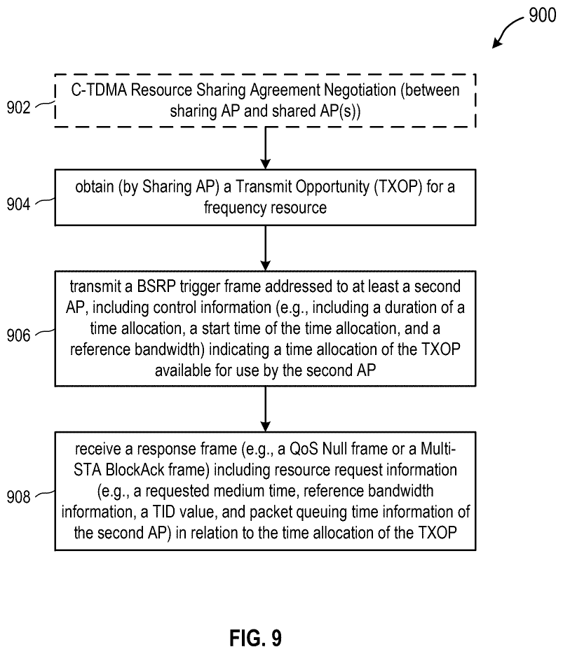

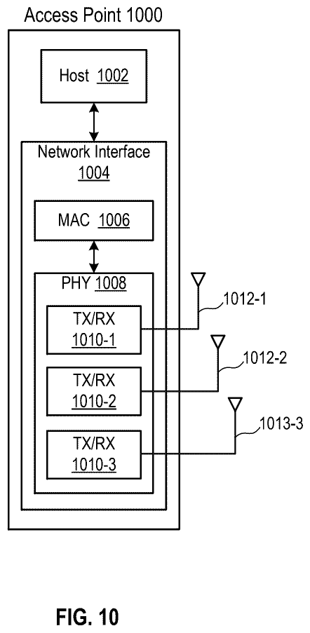

FIG. 9 is a flow chart illustrating an example process 900 for C-TDMA sharing of a frequency resource in accordance with an embodiment of the present disclosure. The process 900 can be performed by an access point (AP), such as the AP MLD 102 described with reference to FIG. 1 or the AP 1000 described with reference to FIG. 10. The process 900 may be utilized, for example, by a sharing AP to perform C-TDMA operations such as described with reference to FIG. 3 and FIG. 4.

The method begins at step 902 where the sharing AP participates in a C-TDMA resource sharing agreement negotiation with one or more other (shared) APs such as described with reference to FIG. 8. The method continues at step 904 were the obtains a TXOP for a frequency resource subject to the resource sharing agreement. In an alternative embodiment, the TXOP opportunity may be obtained prior to the resource sharing agreement negotiation of step 902. The method continues at step 906, where the sharing AP transmits a BSRP trigger frame addressed to at least a second AP to indicate that a time allocation of the TXOP is available to the second AP and to solicit a response from the second AP. The BSRP trigger frame may have a format such as illustrated in FIG. 5 or FIG. 6, and includes various control information, such as a duration of a time allocation of the TXOP, a start time of the time allocation, and/or a reference bandwidth.

The illustrated method continues at step 908, where the sharing AP receives a response frame from the second AP regarding the available time allocation of the TXOP. The response frame may be a QoS Null frame (such as illustrated in FIG. 7) or a Multi-STA BlockAck frame (such as illustrated in FIG. 8) and includes resource request information such as a requested medium time, reference bandwidth information, a TID value, and/or packet queuing time information of the second AP with respect to the available time allocation of the TXOP. In another example, the response frame contains an explicit indication of the acceptance or rejection of the available time allocation of the TXOP.

FIG. 10 illustrates an example of a wireless network device that is configured as an access point (AP) 1000 according to an embodiment of the present disclosure. The AP 1000 is configurable to generate and receive frame formats according to any of the various embodiments described herein, and to perform the described C-TDMA operations. The illustrated AP 1000 includes a host processor 1002 coupled to a network interface device 1004. The network interface device 1004 includes a medium access control (MAC) processing unit 1006 and a physical layer (PHY) processing unit 1008. The PHY processing unit 1008 includes a plurality of transceivers 1010 coupled to a plurality of antennas 1012. Although three transceivers 1010 (1010-1, 1010-2 and 1010-3) and three antennas 1012 (1012-1, 1012-2 and 1012-3) are illustrated in FIG. 1, the AP 1000 includes other suitable numbers (e.g., 1, 2, 4, 5, etc.) of transceivers 1010 and antennas 1012 in other embodiments. In an example, the MAC processing unit 1006 and the PHY processing unit 1008 are configured to operate in compliance with the IEEE 802.11bn amendment to the IEEE 802.11 standard. In an example, the network interface device 1004 includes one or more integrated circuit (IC) devices. In this example, at least some of the functionality of the MAC processing unit 1006 and at least some of the functionality of the PHY processing unit 1008 can be implemented on a single IC device. As another example, at least some of the functionality of the MAC processing unit 1006 is implemented on a first IC device, and at least some of the functionality of the PHY processing unit 1008 is implemented on a second IC device. The AP 1000 may communicate (e.g., C-TDMA related communications) with a plurality of client stations and other APs, including both legacy and non-legacy client APs and stations.

In various embodiments, the PHY processing unit 1008 of the AP 1000 is configured to generate data units conforming to a non-legacy communication protocol and having formats described herein. The transceiver(s) 1010 is/are configured to transmit the generated data units via the antenna(s) 1012. Similarly, the transceiver(s) 1010 is/are configured to receive data units via the antenna(s) 1012. The PHY processing unit 1008 of the AP 1000 is configured to process received data units conforming to the non-legacy communication protocol and having formats described herein and to determine that such data units conform to the non-legacy communication protocol.

In an embodiment, when operating in single-user mode, the AP 1000 transmits a data unit to a single client station (DL SU transmission), or receives a data unit transmitted by a single client station (UL SU transmission), without simultaneous transmission to, or by, any other client station. When operating in multi-user mode, the AP 1000 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP 1000 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 1000 may be configured as a multi-link device, such as the AP MLD 102 described above with reference to FIG. 1.

While the innovate aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative apparatus, frame formats, and methods illustrated in the drawings and described herein enable multi-station operations for C-TDMA to achieve gains in overall network throughput and other potential advantages. In an illustrative, non-limiting embodiment, a method for coordinated time domain multiple access (C-TDMA) sharing of a wireless frequency resource by a first access point (AP) of a device is provided. The method includes obtaining a Transmit Opportunity (TXOP) for the frequency resource and transmitting a Buffer Status Report Poll (BSRP) trigger frame addressed to at least a second AP, the BSRP trigger frame including control information indicating a time allocation of the TXOP available for use by the second AP. The method further includes receiving, in response to the BSRP trigger frame, a response frame including resource request information of the second AP with respect to the time allocation of the TXOP.

The method of this embodiment includes optional aspects. With one optional aspect, the BSRP trigger frame includes a first User Info field addressed to the second AP followed by a second User Info field including the control information. In another optional aspect, a partial Association ID (AID12) subfield of the second User Info field is set to a defined value that indicates the second User Info field includes the control information. In yet another optional aspect, the control information is provided in bits 12 through 39 of the second User Info field, and the control information includes a control identifier (ID) value, a start time of the time allocation, a duration of the time allocation, and reserved bits.

In another optional aspect, the BRSP trigger frame further includes a third User Info field addressed to a third AP followed by a fourth User Info field including second control information indicating a second time allocation of the TXOP available for use by the third AP. In this optional aspect, an AID12 subfield of the fourth User Info field is set to a defined value that indicates the fourth User Info field includes the second control information. In another optional aspect, the control information indicates one or more of a duration of the time allocation, a reference bandwidth, or a start time of the time allocation. In yet another optional aspect, the response frame is a Quality of Service (QOS) Null frame. In a further optional aspect, the QoS Null frame includes a High Efficiency (HE) Control field including an indication of whether or not the second AP accepts the time allocation of the TXOP and, if the time allocation of the TXOP is accepted, a resource request relating to the time allocation. In another optional aspect, the resource request includes a requested medium time, reference bandwidth information, a Traffic Identifier (TID) value, and packet queuing time information.

In another optional aspect, the response frame is a Multi-STA Block Acknowledgement (BA) frame including a BA Information field, wherein the BA Information field includes a resource request relating to the time allocation. In a further optional aspect, the method further includes performing, prior to transmitting the BSRP trigger frame, a frame exchange sequence with the second AP to negotiate a C-TDMA resource sharing agreement between the first AP and the second AP, and the BSRP trigger frame is transmitted in accordance with the C-TDMA resource sharing agreement. In another optional aspect, the C-TDMA resource sharing agreement includes one or more of a start time of the C-TDMA sharing service being provided by the first AP, a service interval, a service period within a service period, a reference bandwidth of the service period, a priority of a requested resource, or a delay bound.

With another illustrative, non-limiting embodiment, a first access point includes one or more wireless transceivers and one or more processors operably coupled to the one or more wireless transceivers. The one or more processors are arranged to execute the operational instructions to obtain, by the first AP, a Transmit Opportunity (TXOP) for a frequency resource and transmit, via the one or more wireless transceivers, a Buffer Status Report Poll (BSRP) trigger frame addressed to at least a second AP, the BSRP trigger frame including control information indicating a time allocation of the TXOP available for use by the second AP. The one or more processors of the first AP are further arranged to receive, via the one or more wireless transceivers, a response frame in response to the BSRP trigger frame, the response frame including resource request information of the second AP with respect to the time allocation of the TXOP.

This second embodiment includes optional aspects. With one optional aspect, the BSRP trigger frame includes a first User Info field addressed to the second AP followed by a second User Info field including the control information. In another optional aspect, a partial Association ID (AID12) subfield of the second User Info field is set to a defined value that indicates the second User Info field includes the control information, and the control information indicates one or more of a duration of the time allocation, a reference bandwidth, or a start time of the time allocation. In still another option aspect, the response frame is a Quality of Service (QOS) Null frame, the QoS Null frame including a High Efficiency (HE) Control field including a resource request relating to the time allocation. In another optional aspect, the resource request includes one or more of a requested medium time, reference bandwidth information, a Traffic Identifier (TID) value, or packet queuing time information.

In another illustrative, non-limiting embodiment, a method for coordinated time domain multiple access (C-TDMA) sharing of a wireless frequency resource by a first access point (AP) of a device is provided. The method includes obtaining a Transmit Opportunity (TXOP) for the frequency resource and transmitting a Buffer Status Report Poll (BSRP) trigger frame addressed to at least a second AP, the BSRP trigger frame including control information indicating a time allocation of the TXOP available for use by the second AP. The method further includes receiving, in response to the BSRP trigger frame, a response frame including resource request information of the second AP with respect to the time allocation of the TXOP. This third embodiment includes optional aspects. With one optional aspect, the control information indicates one or more of a duration of the time allocation, a reference bandwidth, or a start time of the time allocation.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory clement may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for coordinated time domain multiple access (C-TDMA) sharing of a wireless frequency resource by a first access point (AP) of a device, the method comprising:
obtaining a Transmit Opportunity (TXOP) for the wireless frequency resource;
transmitting a Buffer Status Report Poll (BSRP) trigger frame addressed to at least a second AP, the BSRP trigger frame including control information indicating a time allocation of the TXOP available for use by the second AP; and
receiving, in response to the BSRP trigger frame, a response frame including resource request information of the second AP with respect to the time allocation of the TXOP.

2. The method of claim 1, wherein the BSRP trigger frame includes a first User Info field addressed to the second AP followed by a second User Info field including the control information.

3. The method of claim 2, wherein a partial Association ID (AID12) subfield of the second User Info field is set to a defined value that indicates the second User Info field includes the control information.

4. The method of claim 3, wherein the control information is provided in bit 12 through bit 39 of the second User Info field, and the control information includes a control identifier (ID) value, a start time of the time allocation, a duration of the time allocation, and reserved bits.

5. The method of claim 3, wherein the BSRP trigger frame further includes a third User Info field addressed to a third AP followed by a fourth User Info field including second control information indicating a second time allocation of the TXOP available for use by the third AP, and wherein an AID12 subfield of the fourth User Info field is set to a defined value that indicates the fourth User Info field includes the second control information.

6. The method of claim 1, wherein the control information indicates one or more of a duration of the time allocation, a reference bandwidth, or a start time of the time allocation.

7. The method of claim 1, wherein the response frame is a Quality of Service (QOS) Null frame.

8. The method of claim 7, wherein the QoS Null frame includes a High Efficiency (HE) Control field including an indication of whether or not the second AP accepts the time allocation of the TXOP and, if the time allocation of the TXOP is accepted, a resource request relating to the time allocation.

9. The method of claim 8, wherein the resource request includes a requested medium time, reference bandwidth information, a Traffic Identifier (TID) value, and packet queuing time information.

10. The method of claim 1, wherein the response frame is a Multi-STA Block Acknowledgement (BA) frame including a BA Information field, wherein the BA Information field includes a resource request relating to the time allocation.

11. The method of claim 1, further comprising:
performing, prior to transmitting the BSRP trigger frame, a frame exchange sequence with the second AP to negotiate a C-TDMA resource sharing agreement between the first AP and the second AP, wherein the BSRP trigger frame is transmitted in accordance with the C-TDMA resource sharing agreement.

12. The method of claim 11, wherein the C-TDMA resource sharing agreement includes one or more of:
a start time of the C-TDMA resource sharing service being provided by the first AP;
a service interval;
a service period within a service period;
a reference bandwidth of the service period;
a priority of a requested resource; or
a delay bound.

13. A first access point (AP), comprising:
one or more wireless transceivers; and
one or more processors operably coupled to the one or more wireless transceivers, wherein the one or more processors are arranged to:
obtain, by the first AP, a Transmit Opportunity (TXOP) for a frequency resource;
transmit, via the one or more wireless transceivers, a Buffer Status Report Poll (BSRP) trigger frame addressed to at least a second AP, the BSRP trigger frame including control information indicating a time allocation of the TXOP available for use by the second AP; and
receive, via the one or more wireless transceivers, a response frame in response to the BSRP trigger frame, the response frame including resource request information of the second AP with respect to the time allocation of the TXOP.

14. The first AP of claim 13, wherein the BSRP trigger frame includes a first User Info field addressed to the second AP followed by a second User Info field including the control information.

15. The first AP of claim 14, wherein a partial Association ID (AID12) subfield of the second User Info field is set to a defined value that indicates the second User Info field includes the control information, and wherein the control information indicates one or more of a duration of the time allocation, a reference bandwidth, or a start time of the time allocation.

16. The first AP of claim 13, wherein the response frame is a Quality of Service (QOS) Null frame, the QoS Null frame including a High Efficiency (HE) Control field including a resource request relating to the time allocation.

17. The first AP of claim 16, wherein the resource request includes one or more of a requested medium time, reference bandwidth information, a Traffic Identifier (TID) value, or packet queuing time information.

18. The first AP of claim 13, wherein the response frame is a Multi-STA Block Acknowledgement (BA) frame including a BA Information field, wherein the BA Information field includes a resource request relating to the time allocation.

19. A method for coordinated time domain multiple access (C-TDMA) sharing of a wireless frequency resource by a first access point (AP) of a device, the method comprising:
obtaining a Transmit Opportunity (TXOP) for the wireless frequency resource;
transmitting a trigger frame for reception by at least a second AP, the trigger frame including control information indicating a time allocation of the TXOP available for use by the second AP; and
receiving, in response to the trigger frame, a response frame including resource request information of the second AP with respect to the time allocation of the TXOP, wherein the response frame is a Quality of Service (QOS) Null frame or a Multi-STA Block Acknowledgement (BA) frame.

20. The method of claim 19, wherein the control information indicates one or more of a duration of the time allocation, a reference bandwidth, or a start time of the time allocation.
